(19) United States
(12) Patent Application Publication
(10) Pub. No.: US 2026/0320250 A1
(43) Pub. Date: Oct. 15, 2026

(54) METHOD AND SYSTEM FOR DETERMINING CONVECTIVE HEAT TRANSFER COEFFICIENT OF WATER-COOLED MAGNET COIL

(71) Applicant: HEFEI INSTITUTES OF PHYSICAL SCIENCE, CHINESE ACADEMY OF SCIENCES, Hefei (CN)

(72) Inventors: Zhen FANG, Hefei (CN); Guangli KUANG, Hefei (CN); Siming WANG, Hefei (CN); Jian LI, Hefei (CN); Zhongjian WANG, Hefei (CN); Xinxing QIAN, Hefei (CN); Jian SU, Hefei (CN); Yong ZHANG, Hefei (CN)

(21) Appl. No.: 18/996,687

(22) PCT Filed: Mar. 11, 2024
(86) PCT No.: PCT/CN2024/080993

§ 371 Date: Jan. 17, 2025

(30) Foreign Application Priority Data
Nov. 21, 2023 (CN) CN 202311551565.4

(51) Int. Cl. G06F 30/23; G06F 111/10; G06F 119/08

(52) U.S. Cl. CPC G06F 30/23; G06F 2111/10; G06F 2119/08

(57) ABSTRACT

A method for determining convective heat transfer coefficient of water-cooled magnet coil is provided, including: obtaining measured average temperature of water-cooled magnet coil to which current with predetermined current intensity is applied (S10); simulating application of current with predetermined current intensity to three-dimensional model of water-cooled magnet coil in finite element analysis software, and obtaining, through simulation, multiple simulated average temperatures of water-cooled magnet coil corresponding to multiple different wall surface roughnesses (S20); fitting the multiple different wall surface roughnesses and the multiple simulated average temperatures respectively corresponding thereto, and obtaining fitting function (S30); substituting measured average temperature of water-cooled magnet coil into fitting function and obtaining wall surface roughness corresponding to measured average temperature (S40); and substituting wall surface roughness corresponding to measured average temperature of water-cooled magnet coil into finite element analysis software, and obtaining convective heat transfer coefficient of water-cooled magnet coil through simulation (S50). A system for determining convective heat transfer coefficient of water-cooled magnet coil is also provided.

### CROSS-REFERENCE TO RELATED APPLICATIONS

The present disclosure claims priority to Chinese Patent Application No. 202311551565.4 filed with the China National Intellectual Property Administration on Nov. 21, 2023, the entire contents of which are incorporated herein by reference.

### TECHNICAL FIELD

The present disclosure relates to the field of water-cooled magnet technologies, and in particular, to a method for determining a convective heat transfer coefficient of a water-cooled magnet coil and a system therefor.

### BACKGROUND

Water-cooled magnet is an important part of steady high magnetic field facility (SHMFF), which has become a highly concerned extreme-condition experimental platform due to its characteristics such as high magnetic field strength and fast magnetic excitation. Francis Bitter, a physicist at MIT, first proposed the concept of circular ring disk with holes, which is a new way expected to produce a higher magnetic field, so such circular ring disk with holes was later named Bitter disk. The Bitter disk and an insulating plate are two basic elements that form a water-cooled magnet coil. As shown in FIG. 1, the Bitter disk 2 is covered with water-cooled holes and has partition slits. The insulating plate 1 has same water-cooled holes as the Bitter disk 2, while a shape and a size of the Bitter disk 2 are generally a dozen times of those of the insulating plate 1. The Bitter disk 2 and the insulating plate 1 form a water-cooled magnet water flow channel through regular misalignment and stacking, thereby forming a water-cooled magnet coil, and multiple water-cooled magnet coils are combined to form a water-cooled magnet.

As magnetic field strength of the water-cooled magnet continuously increases, operating power also increases, so a thermal stability performance problem of the water-cooled magnet coil becomes increasingly prominent. Currently, a maximum current applied to some water-cooled magnets is close to 40000 A. Such a high current flowing through the magnet definitely generates a large amount of Joule heat. In order to ensure stable operation of the magnet, the Joule heat generated inside the water-cooled magnet is required to be taken away by high-speed and high-pressure deionized cooling water. If the heat is not taken away in time, serious consequences of coil burnout may occur. Therefore, in the design of the water-cooled magnet, the cooling design of the coil is crucial. The convective heat transfer coefficient of a fluid-solid interface is an indispensable key parameter in the cooling design of the water-cooled magnet coil. However, factors such as a shape, a position, a size, and roughness of a water flow channel in the coil may affect the convective heat transfer coefficient. Therefore, it is very difficult to accurately calculate an analytical solution of the convective heat transfer coefficient.

Currently, a method for determining the convective heat transfer coefficient of the water-cooled magnet is mostly an empirical formula method. An empirical formula currently used is h=AV^{p}, where V denotes a velocity of water, the value of p is close to 1, and A is a constant. There is a lot of related academic discussion about the values of A and p, and most people agree that the value of p is roughly in a range from 0.8 to 1.0. However, due to uncertainty of the value of p, the heat transfer coefficient obtained by simply using the empirical formula often has a large deviation from an actual value, which cannot accurately describe heat transfer characteristics of the water-cooled magnet coil. If an experimental measurement method is used to solve the convective heat transfer coefficient of the water-cooled magnet coil, accuracy is relatively high, but development of a large-size dedicated apparatus to withstand high pressure deionized water is required, and the development cost is expensive.

In related technology, it is proposed in the patent application with publication number CN115565745A that stabilities in multiple aspects of electromagnetic heat in the design of a superconducting magnet are analyzed and verified with the use of finite element simulation. When the superconducting magnet is cooled by a cooling medium, an interface between the superconducting magnet and the cooling medium is set as a heat flux boundary. A type of the heat flux is convective heat flux. That is, heat flux of a wall surface is known rather than unknown in a boundary condition.

### SUMMARY

The present disclosure is intended to solve the technical problem of how to improve accuracy and efficiency of solving the heat transfer coefficient of the water-cooled magnet and at the same time reduce research and development costs.

In a first aspect of the present disclosure, a method for determining a convective heat transfer coefficient of a water-cooled magnet coil is proposed. The method includes: obtaining a measured average temperature of the water-cooled magnet coil to which a current with a predetermined current intensity is applied; simulating application of the current with the predetermined current intensity to a three-dimensional model of the water-cooled magnet coil in a finite element analysis software, setting multiple different wall surface roughnesses, and obtaining, through simulation, application simulated average temperatures corresponding to the application different wall surface roughnesses, where the measured average temperature of the water-cooled magnet coil is between a minimum value and a maximum value of the application simulated average temperatures of the water-cooled magnet coil; fitting the application different wall surface roughnesses and the application simulated average temperatures of the water-cooled magnet coil respectively corresponding thereto, and obtaining a fitting function; substituting the measured average temperature of the water-cooled magnet coil into the fitting function and obtaining a wall surface roughness corresponding to the measured average temperature of the water-cooled magnet coil; and substituting the wall surface roughness corresponding to the measured average temperature of the water-cooled magnet coil into the finite element analysis software, and obtaining the convective heat transfer coefficient of the water-cooled magnet coil through simulation.

In the above first aspect, the obtaining the measured average temperature of the water-cooled magnet coil to which the current with the predetermined current intensity is applied includes: applying cooling water at a preset temperature to the water-cooled magnet coil, and in a case that a temperature of the water-cooled magnet coil is equal to the preset temperature of the cooling water, measuring a first voltage across the water-cooled magnet coil to which a first current is applied; calculating a first resistance of the water-cooled magnet coil at the preset temperature based on the first current and the first voltage; measuring a second voltage across the water-cooled magnet coil to which a second current is applied, where current intensity of the second current is greater than that of the first current; and calculating, based on the second current, the second voltage and the first resistance, the measured average temperature of the water-cooled magnet coil to which the second current is applied.

In the above first aspect, the calculating, based on the second current, the second voltage and the first resistance, the measured average temperature of the water-cooled magnet coil to which the second current is applied includes: calculating, based on the second current and the second voltage, a second resistance of the water-cooled magnet coil to which the second current is applied; and calculating, based on the second resistance and the first resistance, the measured average temperature of the water-cooled magnet coil to which the second current is applied.

In the above first aspect, the measured average temperature of the water-cooled magnet coil to which the second current is applied is calculated based on the following formulas:

$${R}_{1} = \frac{{U}_{1}}{{I}_{1}} ,$$

$${R}_{2} = \frac{{U}_{2}}{{I}_{2}} ,$$

$${R}_{2} = {R}_{1} [ 1 + α ( T - 10 ) ] ,$$

where R₁ denotes the first resistance, R₂ denotes the second resistance, U₁ denotes the first voltage, I₁ denotes the first current, U₂ denotes the first voltage, I₂ denotes the first current, α denotes a temperature coefficient of resistivity of the water-cooled magnet coil, and T denotes the measured average temperature of the water-cooled magnet coil to which the second current is applied.

In the above first aspect, the fitting the multiple different wall surface roughnesses and the multiple simulated average temperatures of the water-cooled magnet coil respectively corresponding thereto, and obtaining the fitting function include: fitting the multiple different wall surface roughnesses and the multiple simulated average temperatures of the water-cooled magnet coil respectively corresponding thereto by using Least squares, and obtaining the fitting function, where the fitting function satisfies a minimum sum of squared errors for extracted data.

In the above first aspect, the substituting the wall surface roughness corresponding to the measured average temperature of the water-cooled magnet coil into the finite element analysis software, and obtaining the convective heat transfer coefficient of the water-cooled magnet coil through simulation include: substituting the wall surface roughness corresponding to the measured average temperature of the water-cooled magnet coil into a wall surface condition of a fluid-solid interface, and extracting heat flux and a temperature parameter of the fluid-solid interface; and calculating an average convective heat transfer coefficient at an interface between the water-cooled magnet coil and a fluid domain based on the heat flux and the temperature parameter of the fluid-solid interface.

In the above first aspect, the temperature parameter includes a wall temperature and an average temperature of water, and the calculating the average convective heat transfer coefficient at the interface between the water-cooled magnet coil and the fluid domain based on the heat flux and the temperature parameter of the fluid-solid interface includes calculating the average convective heat transfer coefficient based on the following formula:

$$q = h \cdot ( {T}_{W} - {T}_{f} )$$

where q denotes the heat flux, T_{W} denotes the wall temperature, T_{f} denotes the average temperature of the water, and h denotes the average convective heat transfer coefficient.

In the above first aspect, subsequent to the substituting the wall surface roughness corresponding to the measured average temperature of the water-cooled magnet coil into the finite element analysis software, and obtaining the convective heat transfer coefficient of the water-cooled magnet coil through simulation, the method further includes: retrieving a temperature cloud map from the finite element analysis software to obtain temperature distribution of the water-cooled magnet coil.

In a second aspect of the present disclosure, a system for determining a convective heat transfer coefficient of a water-cooled magnet coil is further proposed. The system includes a temperature measurement module, a temperature simulation module, a fitting module, a wall surface roughness calculation module, and a heat transfer coefficient calculation module. The temperature measurement module is configured to: obtain a measured average temperature of the water-cooled magnet coil to which a current with a predetermined current intensity is applied. The temperature simulation module is configured to simulate application of the current with the predetermined current intensity to a three-dimensional model of the water-cooled magnet coil in a finite element analysis software, set multiple different wall surface roughnesses, and obtain, through simulation, multiple simulated average temperatures of the water-cooled magnet coil corresponding to the multiple different wall surface roughnesses, where the measured average temperature of the water-cooled magnet coil is between a minimum value and a maximum value of the multiple simulated average temperatures of the water-cooled magnet coil. The fitting module is configured to fit the multiple different wall surface roughnesses and the multiple simulated average temperatures of the water-cooled magnet coil respectively corresponding thereto, and obtain a fitting function. The wall surface roughness calculation module is configured to substitute the measured average temperature of the water-cooled magnet coil into the fitting function and obtain a wall surface roughness corresponding to the measured average temperature of the water-cooled magnet coil. The heat transfer coefficient calculation module is configured to substitute the wall surface roughness corresponding to the measured average temperature of the water-cooled magnet coil into the finite element analysis software, and obtain the convective heat transfer coefficient of the water-cooled magnet coil through simulation.
10. The system according to claim 9, wherein the temperature measurement module includes:
a temperature setting unit, configured to apply cooling water at a preset temperature to the water-cooled magnet coil, and in a case that a temperature of the water-cooled magnet coil is equal to the preset temperature of the cooling water, measure a first voltage across the water-cooled magnet coil to which a first current is applied;
a first resistance calculation unit, configured to calculate a first resistance of the water-cooled magnet coil at the preset temperature based on the first current and the first voltage;
a current application unit, configured to measure a second voltage across the water-cooled magnet coil to which a second current is applied, where current intensity of the second current is greater than that of the first current; and
a measured average temperature calculation unit, configured to calculate, based on the second current, the second voltage and the first resistance, the measured average temperature of the water-cooled magnet coil to which the second current is applied.

In the above second aspect, the measured average temperature calculation unit is further configured to: calculate, based on the second current and the second voltage, a second resistance of the water-cooled magnet coil to which the second current is applied; and calculate, based on the second resistance and the first resistance, the measured average temperature of the water-cooled magnet coil to which the second current is applied.

In the above second aspect, the measured average temperature of the water-cooled magnet coil to which the second current is applied is calculated based on the following formulas:

$${R}_{1} = \frac{{U}_{1}}{{I}_{1}} ,$$

$${R}_{2} = \frac{{U}_{2}}{{I}_{2}} ,$$

$${R}_{2} = {R}_{1} [ 1 + α ( T - 10 ) ] ,$$

where R₁ denotes the first resistance, R₂ denotes the second resistance, U₁ denotes the first voltage, I₁ denotes the first current, U₂ denotes the first voltage, I₂ denotes the first current, α denotes a temperature coefficient of resistivity of the water-cooled magnet coil, and T denotes the measured average temperature of the water-cooled magnet coil to which the second current is applied.

In the above second aspect, the fitting module is further configured to: fit the multiple different wall surface roughnesses and the multiple simulated average temperatures of the water-cooled magnet coil respectively corresponding thereto by using Least squares, and obtain the fitting function, where the fitting function satisfies a minimum sum of squared errors for extracted data.

In the above second aspect, the heat transfer coefficient calculation module includes: a parameter calculation unit, configured to substitute the wall surface roughness corresponding to the measured average temperature of the water-cooled magnet coil into a wall surface condition of a fluid-solid interface, and extract heat flux and a temperature parameter of the fluid-solid interface; and a heat transfer coefficient calculation unit, configured to calculate an average convective heat transfer coefficient at an interface between the water-cooled magnet coil and a fluid domain based on the heat flux and the temperature parameter of the fluid-solid interface.

In the above second aspect, the temperature parameter includes a wall temperature and an average temperature of water, and the heat transfer coefficient calculation unit is further configured to calculate the average convective heat transfer coefficient based on the following formula:

$$q = h \cdot ( {T}_{W} - {T}_{f} ) ,$$

where q denotes the heat flux, T_{W} denotes the wall temperature, T_{f} denotes the average temperature of the water, and h denotes the average convective heat transfer coefficient.

In the above second aspect, the system further includes: a temperature distribution analysis module, configured to retrieve a temperature cloud map from the finite element analysis software to obtain temperature distribution of the water-cooled magnet coil.

In a third aspect of the present disclosure, an electronic device is proposed. The electronic device includes a memory, a processor, and a computer program stored in the memory and executable by the processor. The processor, when executing the computer program, implements the method as described in the first aspect.

In a fourth aspect of the present disclosure, a computer-readable storage medium is proposed, having computer-executable instructions stored thereon. The computer-executable instructions, when executed by a processor, cause the processor to implement the method as described in the first aspect.

### BRIEF DESCRIPTION OF THE DRAWINGS

In order to more clearly illustrate the technical solutions in embodiments of the present disclosure or the related technology, the accompanying drawings used in the description of the embodiments or the related technology are briefly introduced below. It is apparent that, the accompanying drawings in the following description are for only some embodiments of the present disclosure, and other drawings can be obtained by those of ordinary skill in the art from the provided drawings without creative efforts.

FIG. 1 is a schematic structural diagram of a water-cooled magnet coil assembled from a Bitter disk and an insulating plate in the related technology;

FIG. 2 is a schematic flowchart of a method for determining a convective heat transfer coefficient of a water-cooled magnet coil according to an embodiment of the present disclosure;

FIG. 3 is a schematic structural diagram of a built three-dimensional model according to an embodiment of the present disclosure;

FIG. 4 is a schematic structural diagram of a system for determining a convective heat transfer coefficient of a water-cooled magnet coil according to an embodiment of the present disclosure;

FIG. 5 is a schematic structural diagram of a temperature measurement module according to an embodiment of the present disclosure;

FIG. 6 is a schematic structural diagram of a heat transfer coefficient calculation module according to an embodiment of the present disclosure;

FIG. 7 is another schematic structural diagram of a system for determining a convective heat transfer coefficient of a water-cooled magnet coil according to an embodiment of the present disclosure; and

FIG. 8 is a schematic structural diagram of an electronic device according to an embodiment of the present disclosure.

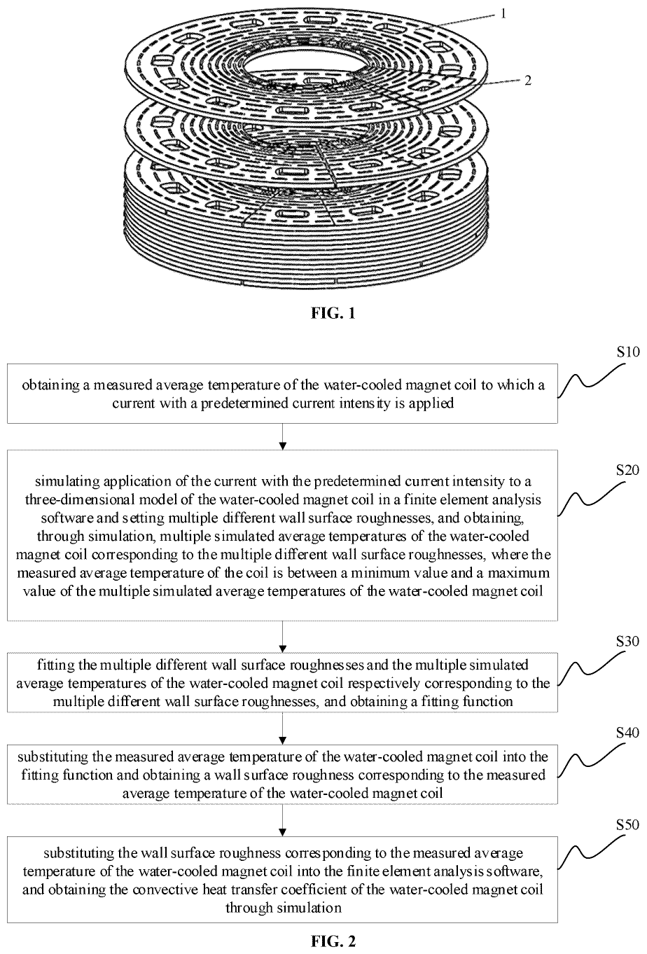

### DETAILED DESCRIPTION

In order to make the objectives, technical solutions, and advantages of the present disclosure clearer, the technical solutions in the embodiments of the present disclosure are clearly and completely described below in conjunction with the accompanying drawings in the present disclosure. Apparently, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

Herein, the description with reference to the terms such as “an embodiment”, “some embodiments”, “example”, “specific example”, and “some examples” mean that a particular feature, structure, material, or characteristic described in connection with the embodiment or example is included in at least one embodiment or example of the present disclosure. Herein, the schematic expressions to the above terms are not necessarily referring to the same embodiment or example. Moreover, the particular feature, structure, material, or characteristic described may be combined in any suitable manner in any one or more embodiments or examples.

Although the terms “first” and “second” may be used herein to describe various features or elements, these features or elements should not be limited by these terms unless specifically stated otherwise. These terms may be used to distinguish one feature or element from another feature or element. Therefore, a first feature or element described below may be referred to as a second feature or element, and similarly, a second feature or element described below may be referred to as a first feature or element, without departing from the scope of the present disclosure.

As shown in FIG. 2, a method for determining a convective heat transfer coefficient of a water-cooled magnet coil is provided according to an embodiment of the present disclosure. The method includes steps S10 to S50.
Step S10 includes: obtaining a measured average temperature of the water-cooled magnet coil to which a current with a predetermined current intensity is applied.
Step S20 includes: simulating application of the current with the predetermined current intensity to a three-dimensional model of the water-cooled magnet coil in a finite element analysis software and setting multiple different wall surface roughnesses, and obtaining, through simulation, multiple simulated average temperatures of the water-cooled magnet coil corresponding to the multiple different wall surface roughnesses, where the measured average temperature of the coil is between a minimum value and a maximum value of the multiple simulated average temperatures of the water-cooled magnet coil.

In the embodiment, the finite element analysis software used includes Fluent fluid simulation software.
Step S30 includes: fitting the multiple different wall surface roughnesses and the multiple simulated average temperatures of the water-cooled magnet coil respectively corresponding to the multiple different wall surface roughnesses, and obtaining a fitting function.

Specifically, in the embodiment, ten different wall surface roughnesses may be set, ten corresponding simulated average temperatures of the water-cooled magnet coil are obtained by simulation, and then the ten wall surface roughnesses and the ten simulated average temperatures of the water-cooled magnet coil respectively corresponding to the ten wall surface roughnesses are fit to obtain the fitting function.
Step S40 includes: substituting the measured average temperature of the water-cooled magnet coil into the fitting function and obtaining a wall surface roughness corresponding to the measured average temperature of the water-cooled magnet coil.
Step S50 includes: substituting the wall surface roughness corresponding to the measured average temperature of the water-cooled magnet coil into the finite element analysis software, and obtaining the convective heat transfer coefficient of the water-cooled magnet coil through simulation.

In the embodiment, by establishing a three-dimensional model of the coil and performing simulation calculation of the water-cooled magnet coil in the finite element analysis software, the multiple simulated average temperatures of the water-cooled magnet coil corresponding to the multiple different wall surface roughnesses are obtained, then the multiple different wall surface roughnesses and the multiple simulated average temperatures of the water-cooled magnet coil respectively corresponding thereto are fit to obtain the fitting function, and the wall surface roughness corresponding to the measured average temperature of the coil is obtained based on the measured average temperature of the coil obtained by experimental measurement. The obtained wall surface roughness may be used as the measured wall surface roughness under an actual working condition, which satisfies that the simulated average temperature is the same as the measured average temperature; that is, heat transfer coefficients are equal. Therefore, by substituting the measured wall surface roughness into the finite element analysis software for simulation, the convective heat transfer coefficient of the fluid-solid interface under the actual working condition can be obtained. In the present disclosure, the convective heat transfer coefficient of the water-cooled magnet coil is obtained by combining numerical simulation and experiments. Compared with the empirical formula and experimental method, efficiency of obtaining the convective heat transfer coefficient of the water-cooled magnet coil is improved, accuracy of the obtained convective heat transfer coefficient is improved, and the research and development costs are reduced.

In an embodiment, step S10 includes steps S11 to S14.
Step S11 includes: applying cooling water at a preset temperature to the water-cooled magnet coil, and in a case that a temperature of the water-cooled magnet coil is equal to the temperature of the water, measuring a first voltage across the water-cooled magnet coil to which a first current is applied.

In the embodiment, the first current is a current with low current intensity, and the current intensity ranges from about 100 A to 200 A.
Step S12 includes: calculating a first resistance of the water-cooled magnet coil at the preset temperature based on the first current and the first voltage.
Step S13 includes: measuring a second voltage across the water-cooled magnet coil to which a second current is applied, where current intensity of the second current is greater than that of the first current.
Step S14 includes: calculating, based on the second current, the second voltage and the first resistance, the measured average temperature of the water-cooled magnet coil to which the second current is applied.

In the embodiment, the second current is a current with high current intensity, and the current intensity ranges from about 38900 A to 40000 A.

In an embodiment, step S14 includes: calculating, based on the second current and the second voltage, a second resistance of the water-cooled magnet coil to which the second current is applied; and calculating, based on the second resistance and the first resistance, the measured average temperature of the water-cooled magnet coil to which the second current is applied.

In an embodiment, the measured average temperature of the water-cooled magnet coil to which the second current is applied is calculated based on the following formulas:

$${R}_{1} = \frac{{U}_{1}}{{I}_{1}} ,$$

$${R}_{2} = \frac{{U}_{2}}{{I}_{2}} ,$$

$${R}_{2} = {R}_{1} [ 1 + α ( T - 10 ) ] ,$$

where R₁ denotes the first resistance, R₂ denotes the second resistance, U₁ denotes the first voltage, I₁ denotes the first current, U₂ denotes the first voltage, I₂ denotes the first current, α denotes a temperature coefficient of resistivity of the water-cooled magnet coil, and T denotes the measured average temperature of the water-cooled magnet coil to which the second current is applied.

Specifically, an actual process of measuring an average temperature of the coil includes:
applying cooling water at 10 degrees Celsius to the water-cooled magnet coil for half an hour, where after that, the temperature of the water-cooled magnet coil is equal to the temperature of the water and is 10 degrees Celsius; applying a low current with current intensity of 100 A to the water-cooled magnet coil, measuring a voltage across the water-cooled magnet coil, and calculating the first resistance based on the measured voltage and the current:

$${R}_{1} = \frac{{U}_{1}}{{I}_{1}} ;$$

then applying a high current with current intensity of 38900 A to the water-cooled magnet coil, measuring a corresponding second voltage, and calculating the second resistance of the water-cooled magnet coil at this time:

$${R}_{2} = \frac{{U}_{2}}{{I}_{2}} ;$$

and then calculating, according to an equation

$${R}_{2} = {R}_{1} [ 1 + α ( T - 10 ) ] ,$$

the measured average temperature of the water-cooled magnet coil to which the current of 38900 A is applied.

In an embodiment, the measured average temperature of the water-cooled magnet coil is between a minimum value and a maximum value of the simulated average temperatures of the water-cooled magnet coil.

Specifically, if the measured average temperature of the water-cooled magnet coil is not between the minimum value and the maximum value of the simulated average temperatures of the water-cooled magnet coil, the wall surface roughness is modified to cause the measured average temperature of the water-cooled magnet coil to be between the minimum value and the maximum value of the simulated average temperatures of the water-cooled magnet coil.

In an embodiment, step S30 includes: fitting the multiple different wall surface roughnesses and the multiple simulated average temperatures of the water-cooled magnet coil respectively corresponding to the multiple different wall surface roughnesses by using Least Squares, and obtaining a fitting function, where the fitting function satisfies a minimum sum of squared errors for extracted data.

In the embodiment, origin software may be used to perform data fitting by means of the Least Squares, to obtain the fitting function.

In an embodiment, step S50 includes steps S51 and S52.
Step S51 includes: substituting the wall surface roughness corresponding to the measured average temperature of the water-cooled magnet coil into a wall surface condition of a fluid-solid interface, and extracting heat flux and a temperature parameter of the fluid-solid interface.
Step S52 includes: calculating an average convective heat transfer coefficient at an interface between the water-cooled magnet coil and a fluid domain based on the heat flux and the temperature parameter of the fluid-solid interface.

Specifically, the temperature parameter includes a wall temperature and an average temperature of water. Step S52 is implemented based on the following formula:

$$q = h \cdot ( {T}_{W} - {T}_{f} ) ,$$

where q denotes the heat flux, T_{W} denotes the wall temperature, T_{f} denotes the average temperature of the water, and h denotes the average convective heat transfer coefficient.

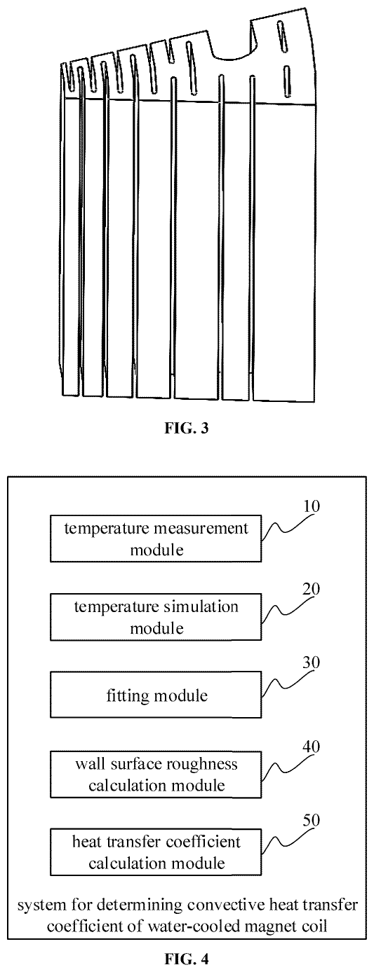

In an embodiment, a specific process of simulating the three-dimensional model of the water-cooled magnet coil in the finite element analysis software includes: establishing a three-dimensional model of the water-cooled magnet coil and the fluid domain, and performing boundary layer meshing at the fluid-solid interface in the three-dimensional model. For example, as shown in FIG. 3, one twenty-fourth of the water-cooled magnet coil and the fluid domain is illustrated as the three-dimensional model, and hexahedron meshing is performed at the fluid-solid interface in the three-dimensional model to obtain a meshed three-dimensional model.

Specifically, in the embodiment, the three-dimensional model of one twenty-fourth of the water-cooled magnet coil and the fluid domain is established based on numbers and sizes of Bitter disks and insulating plates. As shown in FIG. 3, a coil model is simplified based on 12 fixed rod holes in the Bitter disk, to improve computing efficiency.

Then, a boundary condition and structural property parameters of the three-dimensional model are set. The boundary condition includes a symmetry boundary condition, a voltage boundary condition, inlet and outlet boundary conditions, and a wall surface condition. The structural property parameters are parameters that consider the impact of temperature on properties, including viscosity, density, specific heat, thermal conductivity, and resistivity.

Then, electric field-temperature-fluid field simulation calculation is performed on the meshed three-dimensional model to obtain a temperature distribution simulation result of the water-cooled magnet coil, including:
performing electric field-temperature-fluid field simulation calculation on the meshed three-dimensional model by using a k-epsilon turbulence model, to obtain the temperature distribution simulation result of the water-cooled magnet coil.

Electric field governing equations are as follows:

$$∇ \cdot J = {Q}_{j} ,$$

$$J = σ E + {J}_{e} ,$$

$$E = - {∇}_{ϕ} ,$$

where ∇ denotes a vector differential operator; J denotes a current density vector; Qⱼ denotes a current source; α denotes conductivity; E denotes an electric field intensity vector; φ denotes potential; and Je denotes external injection current density.

Temperature and fluid field governing equations are as follows:

$$\frac{\partial ρ}{\partial t} + ∇ \cdot ( ρ v ) = 0 ,$$

$$\frac{\partial ( ρ v )}{\partial t} + ρ v \cdot ∇ v = ρ f - ∇ p + μ {∇}^{2} v , and$$

$$\frac{\partial ( ρ v )}{\partial t} + ∇ \cdot ( ρ ev ) = ρ q + ∇ ( k ∇ T ) - P ∇ v + S ,$$

where ∇ denotes a Hamiltonian operator; f denotes a mass force per unit mass of fluid; q denotes volume heat flow of the magnet; ρ denotes density of the fluid; ν denotes a velocity vector of the fluid; P denotes a pressure of the fluid; μ denotes dynamic viscosity of the fluid; e denotes internal energy of the fluid; k denotes thermal conductivity of the fluid; S denotes a part of thermal energy converted from mechanical energy of the fluid under a combined action of internal heat sources of the fluid; t denotes time; and T denotes the temperature.

In the embodiment, by combining numerical simulation and experiments to obtain the convective heat transfer coefficient, electric field-temperature-fluid field joint simulation calculation of the water-cooled magnet coil is performed, and the simulated average temperatures of the water-cooled magnet coil corresponding to different wall surface roughnesses are obtained.

In an embodiment, after step S50, the method further includes: retrieving a temperature cloud map from the finite element analysis software to obtain temperature distribution of the water-cooled magnet coil.

In the embodiment, distribution of temperature, heat flow, and the like at respective fluid-solid interfaces as well as overall temperature distribution of the coil can be accurately acquired.

Each step of the above method can be performed by any suitable apparatus that can perform a corresponding function. Such apparatus may include various hardware and/or software components and/or modules, including, but not limited to, circuits, application specific integrated circuits (ASICs), or processors. It should be understood that, although the steps in the flowcharts shown in the drawings are shown in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts shown in the drawings may include multiple sub-steps or multiple stages, and such sub-steps or stages are not necessarily performed at a same moment, and may be performed at different moments. The sub-steps or stages are not necessarily performed in sequence, and the sub-steps or stages and at least some of other steps or sub-steps or stages of other steps may be performed in turn or alternately.

Referring to FIG. 4, a system for determining a convective heat transfer coefficient of a water-cooled magnet coil is further provided according to an embodiment of the present disclosure. The system includes a temperature measurement module 10, a temperature simulation module 20, a fitting module 30, a wall surface roughness calculation module 40, and a heat transfer coefficient calculation module 50.

The temperature measurement module 10 is configured to obtain a measured average temperature of the water-cooled magnet coil to which a current with a predetermined current intensity is applied. The temperature simulation module 20 is configured to simulate application of the current with the predetermined current intensity to a three-dimensional model of the water-cooled magnet coil in a finite element analysis software, set multiple different wall surface roughnesses, and obtain, through simulation, multiple simulated average temperatures of the water-cooled magnet coil corresponding to the multiple different wall surface roughnesses. The measured average temperature of the water-cooled magnet coil is between a minimum value and a maximum value of the multiple simulated average temperatures of the water-cooled magnet coil. The fitting module 30 is configured to fit the multiple different wall surface roughnesses and the multiple simulated average temperatures of the water-cooled magnet coil respectively corresponding to the multiple different wall surface roughnesses, and obtain a fitting function. The wall surface roughness calculation module 40 is configured to substitute the measured average temperature of the water-cooled magnet coil into the fitting function and obtain a wall surface roughness corresponding to the measured average temperature of the water-cooled magnet coil. The heat transfer coefficient calculation module 50 is configured to substitute the wall surface roughness corresponding to the measured average temperature of the water-cooled magnet coil into the finite element analysis software, and obtain the convective heat transfer coefficient of the water-cooled magnet coil through simulation.

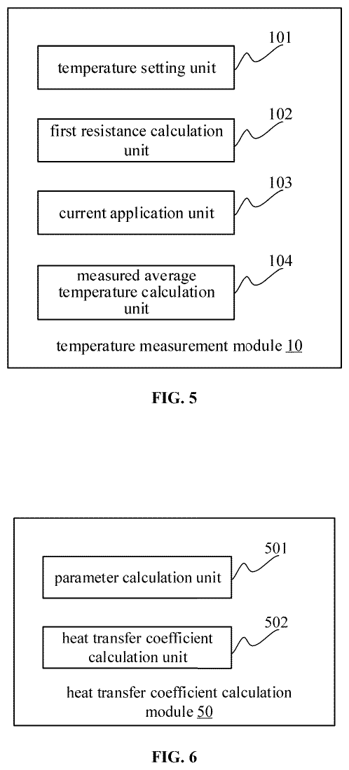

In an embodiment, as shown in FIG. 5, the temperature measurement module 10 includes a temperature setting unit 101, a first resistance calculation unit 102, a current application unit 103, and a measured average temperature calculation unit 104. The temperature setting unit 101 is configured to apply cooling water at a preset temperature to the water-cooled magnet coil, and in a case that a temperature of the water-cooled magnet coil is equal to the temperature of the water, measure a first voltage across the water-cooled magnet coil to which a first current is applied. The first resistance calculation unit 102 is configured to calculate a first resistance of the water-cooled magnet coil at the preset temperature based on the first current and the first voltage. The current application unit 103 is configured to measure a second voltage across the water-cooled magnet coil to which a second current is applied, where current intensity of the second current is greater than that of the first current. The measured average temperature calculation unit 104 is configured to calculate, based on the second current, the second voltage and the first resistance, the measured average temperature of the water-cooled magnet coil to which the second current is applied.

In an embodiment, the measured average temperature calculation unit is further configured to: calculate, based on the second current and the second voltage, a second resistance of the water-cooled magnet coil to which the second current is applied; and calculate, based on the second resistance and the first resistance, the measured average temperature of the water-cooled magnet coil to which the second current is applied.

In an embodiment, the measured average temperature of the water-cooled magnet coil to which the second current is applied is calculated based on the following formulas:

$${R}_{1} = \frac{{U}_{1}}{{I}_{1}} ,$$

$${R}_{2} = \frac{{U}_{2}}{{I}_{2}} , and$$

$${R}_{2} = {R}_{1} [ 1 + α ( T - 10 ) ] ,$$

where R₁ denotes the first resistance, R₂ denotes the second resistance, U₁ denotes the first voltage, I₁ denotes the first current, U₂ denotes the first voltage, I₂ denotes the first current, α denotes a temperature coefficient of resistivity of the water-cooled magnet coil, and T denotes the measured average temperature of the water-cooled magnet coil to which the second current is applied.

In an embodiment, the fitting module 30 is further configured to: fit the multiple different wall surface roughnesses and the multiple simulated average temperatures of the water-cooled magnet coil respectively corresponding to the multiple different wall surface roughnesses by using Least Squares, and obtain a fitting function. The fitting function satisfies a minimum sum of squared errors for extracted data.

In an embodiment, as shown in FIG. 6, the heat transfer coefficient calculation module 50 includes a parameter calculation unit 501 and a heat transfer coefficient calculation unit 502. The parameter calculation unit 501 is configured to substitute the wall surface roughness corresponding to the measured average temperature of the water-cooled magnet coil into a wall surface condition of a fluid-solid interface, and extract heat flux and a temperature parameter of the fluid-solid interface. The heat transfer coefficient calculation unit 502 is configured to calculate an average convective heat transfer coefficient at an interface between the water-cooled magnet coil and a fluid domain based on the heat flux and the temperature parameter of the fluid-solid interface.

In an embodiment, the temperature parameter includes a wall temperature and an average temperature of water, and the convective heat transfer coefficient is calculated based on the following formula:

$$q = h \cdot ( {T}_{W} - {T}_{f} ) ,$$

where q denotes the heat flux, T_{W} denotes the wall temperature, T_{f} denotes the average temperature of the water, and h denotes the average convective heat transfer coefficient.

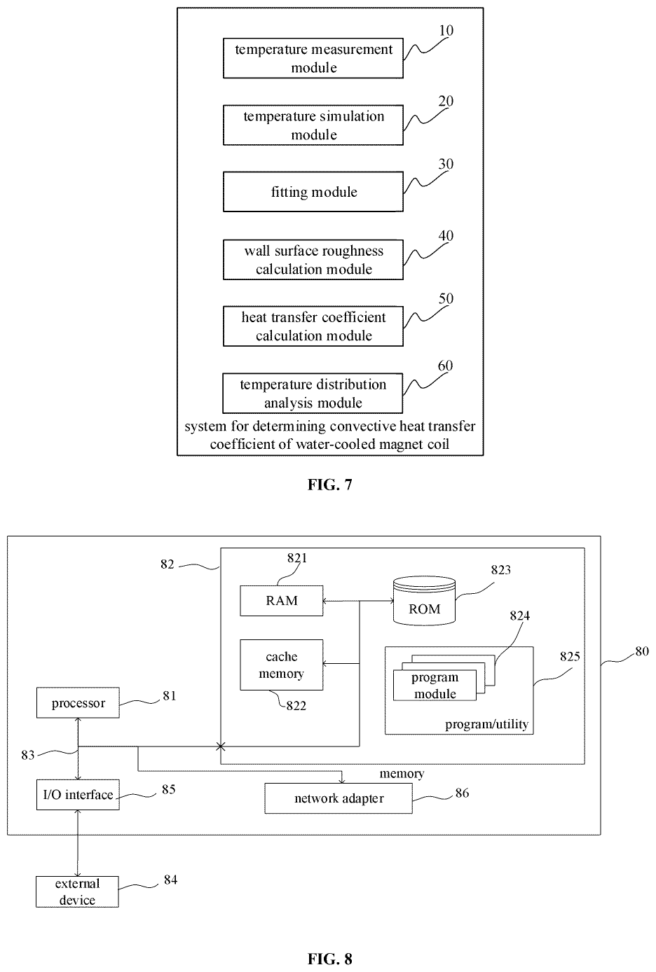

In an embodiment, as shown in FIG. 7, the system further includes a temperature distribution analysis module 60. The temperature distribution analysis module 60 is configured to retrieve a temperature cloud map from the finite element analysis software to obtain temperature distribution of the water-cooled magnet coil.

The modules or units involved in the above system for determining the convective heat transfer coefficient of the water-cooled magnet coil may be implemented by hardware or software. In particular, each block in the block diagram illustrating the system for determining the convective heat transfer coefficient of the water-cooled magnet coil and combinations of blocks in the block diagram may be implemented with a specialized hardware-based system that perform specified functions or operations, or may be implemented using a combination of specialized hardware and computer instructions. It may be understood that the name of the module or unit does not constitute a limitation on the module or unit under certain circumstance. For example, the “temperature measurement module” may also be described as “module configured to obtain a measured temperature”.

FIG. 8 schematically illustrates a structure of an electronic device according to an embodiment of the present disclosure. The electronic device includes a memory, a processor, and a computer program stored in the memory and executable by the processor. When the processor executes the computer program, the method for determining the convective heat transfer coefficient of the water-cooled magnet coil described in the above embodiments is implemented. An electronic device 80 shown in FIG. 8 is merely an example, and should not bring any limitations to the functions and scope of use of the embodiments of the present disclosure.

As shown in FIG. 8, the electronic device 80 may be represented in the form of a computing device, such as a server device. Components of the electronic device 80 may include, but are not limited to: at least one processor 81, at least one memory 82, and a bus 83 connecting different system components (including the memory 82 and the processor 81).

The bus 83 includes a data bus, an address bus, and a control bus.

The memory 82 may include a volatile memory, such as a random access memory (RAM) 821 and/or a cache memory 822, and may further include a read-only memory (ROM) 823.

The memory 82 may further include a program/utility 825 having a set of program module(s) 824 (at least one program module 824). Such program module 824 includes, but is not limited to, an operating system, one or more application programs, other program modules, and program data. Each or any combination of these examples may include implementation of a network environment.

The processor 81 executes various functional applications and data processing by running computer programs stored in the memory 82, such as the medical image reconstruction method described in the first embodiment of the present disclosure.

The electronic device 80 may also communicate with one or more external devices 84 (such as a keyboard and a pointing device). Such communication may occur through an input/output (I/O) interface 85. Moreover, the model-generated device 80 may also communicate with one or more networks (e.g., a local area network (LAN), a wide area network (WAN), and/or a public network such as the Internet) through a network adapter 86.

As shown in FIG. 5, the network adapter 86 communicates with other modules of the model-generated device 80 via the bus 83. It should be understood that, although not shown, other hardware and/or software components may be used in conjunction with the model-generated device 80, including, but not limited to, microcode, device drivers, redundant processing units, external disk drive arrays, redundant arrays of independent disks (RAID) systems, tape drives, data archival storage systems, and the like.

It should be noted that, although several units/modules or sub-units/sub-modules of the electronic device are mentioned in the above detailed description, such division is merely exemplary and not mandatory. Actually, according to implementations of the present disclosure, the features and functions of two or more units/modules described above may be embodied in one unit/module. Conversely, the features and functions of one unit/module described above may be further divided into being embodied by multiple units/modules.

Embodiments of the present disclosure further provide a computer-readable storage medium. The computer-readable storage medium stores computer-executable instructions. When the computer-executable instructions are executed by a processor, the processor is caused to implement the method for determining the convective heat transfer coefficient of the water-cooled magnet coil described in the above embodiments.

The computer-readable storage medium may be a computer-readable signal medium or a computer-readable storage medium, or any combination thereof. For example, the computer-readable storage medium may be, but not limited to, an electronic, magnetic, optical, electromagnetic, infrared, or semiconductor system, apparatus, or device, or any combination thereof. More specific examples of the computer-readable storage medium may include, but not limited to, an electrical connection having one or more wires, a portable computer disk, a hard disk, a RAM, a ROM, an erasable programmable read-only memory (EPROM) or flash memory, an optical fiber, a portable compact disc read-only memory (CD-ROM), an optical storage device, a magnetic storage device, or any suitable combination thereof. In the present disclosure, the computer-readable storage medium may be any tangible medium that may include or store a program for use by or in connection with an instruction execution system, apparatus, or device. In the present disclosure, the computer-readable signal medium may include a data signal propagated in baseband or as part of a carrier wave, carrying computer-readable program code thereon. Such a propagated signal may take a variety of forms, including, but not limited to, electromagnetic signal, optical signal, or any suitable combination thereof. The computer-readable signal medium may alternatively be any computer-readable storage medium other than the computer-readable storage medium. The computer-readable signal medium may send, propagate, or transmit a program for use by or in connection with an instruction execution system, apparatus, or device. Computer codes included on the computer-readable storage medium may be transmitted through any appropriate medium, including, but not limited to, wires, optical cables, radio frequency (RF), and the like, or any suitable combination thereof.

Through the description of the above implementations, those skilled in the art can clearly understand that the methods in the above embodiments can be implemented by means of software plus a necessary general hardware platform; of course, they may alternatively be implemented by hardware. In many cases, the former is preferred. Based on such understanding, the technical solutions in the present disclosure essentially or the part contributing to the prior art may be implemented in the form of a software product. The computer software product is stored in a storage medium (such as a ROM/RAM, a magnetic disc, or an optical disc) as described above, and includes several instructions for instructing a terminal device (which may be a mobile phone, a computer, a server, a network device, or the like) to perform the methods described in the embodiments of the present disclosure.

Although the embodiments of the present disclosure have been shown and described above, it may be understood that the above embodiments are illustrative and cannot be construed as limiting the present disclosure. Those of ordinary skill in the art may make changes, modifications, substitutions, and variations to the above embodiments within the scope of the present disclosure.

1. A method for determining a convective heat transfer coefficient of a water-cooled magnet coil, comprising:
obtaining a measured average temperature of the water-cooled magnet coil to which a current with a predetermined current intensity is applied;
simulating application of the current with the predetermined current intensity to a three-dimensional model of the water-cooled magnet coil in a finite element analysis software, setting a plurality of different wall surface roughnesses, and obtaining, through simulation, a plurality of simulated average temperatures of the water-cooled magnet coil corresponding to the plurality of different wall surface roughnesses, wherein the measured average temperature of the water-cooled magnet coil is between a minimum value and a maximum value of the plurality of simulated average temperatures of the water-cooled magnet coil;
fitting the plurality of different wall surface roughnesses and the plurality of simulated average temperatures of the water-cooled magnet coil respectively corresponding to the plurality of different wall surface roughnesses, and obtaining a fitting function;
substituting the measured average temperature of the water-cooled magnet coil into the fitting function and obtaining a wall surface roughness corresponding to the measured average temperature of the water-cooled magnet coil; and
substituting the wall surface roughness corresponding to the measured average temperature of the water-cooled magnet coil into the finite element analysis software, and obtaining the convective heat transfer coefficient of the water-cooled magnet coil through simulation.

2. The method according to claim 1, wherein the obtaining the measured average temperature of the water-cooled magnet coil to which the current with the predetermined current intensity is applied comprises:
applying cooling water at a preset temperature to the water-cooled magnet coil, and in a case that a temperature of the water-cooled magnet coil is equal to the preset temperature of the cooling water, measuring a first voltage across the water-cooled magnet coil to which a first current is applied;
calculating a first resistance of the water-cooled magnet coil at the preset temperature based on the first current and the first voltage;
measuring a second voltage across the water-cooled magnet coil to which a second current is applied, wherein current intensity of the second current is greater than that of the first current; and
calculating, based on the second current, the second voltage and the first resistance, the measured average temperature of the water-cooled magnet coil to which the second current is applied.

3. The method according to claim 2, wherein the calculating, based on the second current, the second voltage and the first resistance, the measured average temperature of the water-cooled magnet coil to which the second current is applied comprises:
calculating, based on the second current and the second voltage, a second resistance of the water-cooled magnet coil to which the second current is applied; and
calculating, based on the second resistance and the first resistance, the measured average temperature of the water-cooled magnet coil to which the second current is applied.

4. The method according to claim 3, wherein the measured average temperature of the water-cooled magnet coil to which the second current is applied is calculated based on following formulas:
$${R}_{1} = \frac{{U}_{1}}{{I}_{1}} ,$$
$${R}_{2} = \frac{{U}_{2}}{{I}_{2}} ,$$
$${R}_{2} = {R}_{1} [ 1 + α ( T - 10 ) ] ,$$
where R₁ denotes the first resistance, R₂ denotes the second resistance, U₁ denotes the first voltage, I₁ denotes the first current, U₂ denotes the second voltage, I₂ denotes the second current, α denotes a temperature coefficient of resistivity of the water-cooled magnet coil, and T denotes the measured average temperature of the water-cooled magnet coil to which the second current is applied.

5. The method according to claim 1, wherein the fitting the plurality of different wall surface roughnesses and the plurality of simulated average temperatures of the water-cooled magnet coil respectively corresponding to the plurality of different wall surface roughnesses, and obtaining the fitting function comprise:
fitting the plurality of different wall surface roughnesses and the plurality of simulated average temperatures of the water-cooled magnet coil respectively corresponding to the plurality of different wall surface roughnesses by using Least Squares, and obtaining the fitting function, wherein the fitting function satisfies a minimum sum of squared errors for extracted data.

6. The method according to claim 1, wherein the substituting the wall surface roughness corresponding to the measured average temperature of the water-cooled magnet coil into the finite element analysis software, and obtaining the convective heat transfer coefficient of the water-cooled magnet coil through simulation comprise:
substituting the wall surface roughness corresponding to the measured average temperature of the water-cooled magnet coil into a wall surface condition of a fluid-solid interface, and extracting heat flux and a temperature parameter of the fluid-solid interface; and
calculating an average convective heat transfer coefficient at an interface between the water-cooled magnet coil and a fluid domain based on the heat flux and the temperature parameter of the fluid-solid interface.

7. The method according to claim 6, wherein the temperature parameter comprises a wall temperature and an average temperature of water, and the calculating the average convective heat transfer coefficient at the interface between the water-cooled magnet coil and the fluid domain based on the heat flux and the temperature parameter of the fluid-solid interface comprises calculating the average convective heat transfer coefficient based on following formula:
$$q = h \cdot ( {T}_{w} - {T}_{f} ) ,$$
where q denotes the heat flux, T_{W} denotes the wall temperature, T_{f} denotes the average temperature of the water, and h denotes the average convective heat transfer coefficient.

8. The method according to claim 1, wherein subsequent to the substituting the wall surface roughness corresponding to the measured average temperature of the water-cooled magnet coil into the finite element analysis software, and obtaining the convective heat transfer coefficient of the water-cooled magnet coil through simulation, the method further comprises:
retrieving a temperature cloud map from the finite element analysis software to obtain temperature distribution of the water-cooled magnet coil.

9. A system for determining a convective heat transfer coefficient of a water-cooled magnet coil, comprising a memory, a processor, and a computer program stored in the memory and executable by the processor, wherein the processor, when executing the computer program, implements:
obtaining a measured average temperature of the water-cooled magnet coil to which a current with a predetermined current intensity is applied;
simulating application of the current with the predetermined current intensity to a three-dimensional model of the water-cooled magnet coil in a finite element analysis software, setting a plurality of different wall surface roughnesses, and obtaining, through simulation, a plurality of simulated average temperatures of the water-cooled magnet coil corresponding to the plurality of different wall surface roughnesses, wherein the measured average temperature of the water-cooled magnet coil is between a minimum value and a maximum value of the plurality of simulated average temperatures of the water-cooled magnet coil;
fitting the plurality of different wall surface roughnesses and the plurality of simulated average temperatures of the water-cooled magnet coil respectively corresponding to the multiple different wall surface roughnesses, and obtaining a fitting function;
substituting the measured average temperature of the water-cooled magnet coil into the fitting function and obtaining a wall surface roughness corresponding to the measured average temperature of the water-cooled magnet coil; and
substituting the wall surface roughness corresponding to the measured average temperature of the water-cooled magnet coil into the finite element analysis software, and obtaining the convective heat transfer coefficient of the water-cooled magnet coil through simulation.

10. The system according to claim 9, wherein the processor, when executing the computer program, implements:
applying cooling water at a preset temperature to the water-cooled magnet coil, and in a case that a temperature of the water-cooled magnet coil is equal to the preset temperature of the cooling water, measuring a first voltage across the water-cooled magnet coil to which a first current is applied;
calculating a first resistance of the water-cooled magnet coil at the preset temperature based on the first current and the first voltage;
measuring a second voltage across the water-cooled magnet coil to which a second current is applied, wherein current intensity of the second current is greater than that of the first current; and
calculating, based on the second current, the second voltage and the first resistance, the measured average temperature of the water-cooled magnet coil to which the second current is applied.

11. The system according to claim 10, wherein the processor, when executing the computer program, implements:
calculating, based on the second current and the second voltage, a second resistance of the water-cooled magnet coil to which the second current is applied; and
calculating, based on the second resistance and the first resistance, the measured average temperature of the water-cooled magnet coil to which the second current is applied.

12. The system according to claim 11, wherein the measured average temperature of the water-cooled magnet coil to which the second current is applied is calculated based on following formulas:
$${R}_{1} = \frac{{U}_{1}}{{I}_{1}} ,$$
$${R}_{2} = \frac{{U}_{2}}{{I}_{2}} ,$$
$${R}_{2} = {R}_{1} [ 1 + α ( T - 10 ) ] ,$$
where R₁ denotes the first resistance, R₂ denotes the second resistance, U₁ denotes the first voltage, I₁ denotes the first current, U₂ denotes the second voltage, I₂ denotes the second current, c denotes a temperature coefficient of resistivity of the water-cooled magnet coil, and T denotes the measured average temperature of the water-cooled magnet coil to which the second current is applied.

13. The system according to claim 9, wherein the processor, when executing the computer program, implements:
fitting the plurality of different wall surface roughnesses and the plurality of simulated average temperatures of the water-cooled magnet coil respectively corresponding to the plurality of different wall surface roughnesses by using Least squares, and obtaining the fitting function, wherein the fitting function satisfies a minimum sum of squared errors for extracted data.

14. The system according to claim 9, wherein the processor, when executing the computer program, implements:
substituting the wall surface roughness corresponding to the measured average temperature of the water-cooled magnet coil into a wall surface condition of a fluid-solid interface, and extracting heat flux and a temperature parameter of the fluid-solid interface; and
calculating an average convective heat transfer coefficient at an interface between the water-cooled magnet coil and a fluid domain based on the heat flux and the temperature parameter of the fluid-solid interface.

15. The system according to claim 14, wherein the temperature parameter comprises a wall temperature and an average temperature of water, and the processor, when executing the computer program, implements calculating the average convective heat transfer coefficient based on following formula:
$$q = h \cdot ( {T}_{w} - {T}_{f} ) ,$$
where q denotes the heat flux, T_{W} denotes the wall temperature, T_{f} denotes the average temperature of the water, and h denotes the average convective heat transfer coefficient.

16. The system according to claim 9, the processor, when executing the computer program, further implements:
retrieving a temperature cloud map from the finite element analysis software to obtain temperature distribution of the water-cooled magnet coil.

17. (canceled)

18. A computer-readable storage medium, having computer-executable instructions stored thereon, wherein the computer-executable instructions, when executed by a processor, cause the processor to implement the method according to claim 1.
